(19) United States
(12) Patent Application Publication
(10) Pub. No.: US 2018/0086350 A1
(43) Pub. Date: Mar. 29, 2018

(54) METHOD FOR EVALUATING A DRIVER ASSISTANCE FUNCTION OF A MOTOR VEHICLE

(71) Applicant: Robert Bosch GmbH, Stuttgart (DE)

(72) Inventors: Frank Kible, Steinheim A. D. Murr (DE); Simon Hauber, Freiberg Am Neckar (DE)

(21) Appl. No.: 15/573,322

(22) PCT Filed: Apr. 7, 2016
(86) PCT No.: PCT/EP2016/057588

§ 371 Date: Nov. 10, 2017

(30) Foreign Application Priority Data
May 29, 2015 (DE) 10 2015 209 969.5

(51) Int. Cl. B60W 50/02; G07C 5/00; G07C 5/08; B60W 40/02; B60W 40/09; B60W 50/04

(52) U.S. Cl. CPC B60W 50/0205; G07C 5/008; G07C 5/085; B60W 40/02; B60W 40/09; B60W 2550/408; B60W 50/045; B60W 2050/021; B60W 2050/041; B60W 2550/20; B60W 50/0225

(57) ABSTRACT

A method for evaluating a driver assistance function of a motor vehicle, including operating the motor vehicle with the driver assistance function; recording first data on surroundings of the motor vehicle; recording second data on a driver of the motor vehicle; transmitting the first and second data to a database; functional networking of the data within the database; and assessing the driver assistance function as a function of the networked data.

### FIELD

The present invention relates to a method for evaluating a driver assistance function of a motor vehicle. The present invention also relates to a device for evaluating a driver assistance function of a motor vehicle.

### BACKGROUND INFORMATION

Automated operation of motor vehicles are available. For example, adaptive cruise control ACC, lane keeping assistance systems, blind-spot detection systems, automatic emergency brake systems, parking assist, traffic-jam assist, etc. are systems for realizing a partially autonomous vehicle operation including longitudinal controllers, lateral guidance, etc., of the motor vehicle. Speed limiting devices that enable maximum speeds to be set for the longitudinal controllers to ensure that the motor vehicle cannot be accelerated to higher speeds, are also available.

In automated driving, it is intended that the motor vehicle detect the surroundings without any human assistance, and exclusively with the aid of sensors, and bring the driver reliably and without the occurrence of any accidents to his/her destination. To that end, various sensors are used for capturing the surroundings of the motor vehicle.

Technologies are also available that monitor and record a physical or physiological state of the motor vehicle driver. It can be provided that a driver be identified, that his/her level of attentiveness and physical condition be recognized, and that his/her intentions be ascertained.

So far, developments have been in accordance with what is generally referred to as the V-model: worst cases are derived from a technical specification that includes specific applications. However, the V-model does not allow a specification to be created that is detailed enough to cover all possible road traffic situations.

### SUMMARY

It is an object of the present invention to provide an improved method for evaluating a driver assistance function for a motor vehicle.

A first aspect provides that the objective be achieved by a method for evaluating a driver assistance function of a motor vehicle, including the steps of:
operating the motor vehicle with the driver assistance function;
recording first data on surroundings of the motor vehicle;
recording second data on a driver of the motor vehicle;
transmitting first and second data to a database;
functional networking of the data within the database; and
assessing the driver assistance function as a function of the networked data.

A second aspect provides that the objective be achieved by a device for evaluating a driver assistance function of a motor vehicle, including:
a first data acquisition device for recording data from surroundings of the motor vehicle during an operation thereof with the driver assistance function;
a second data acquisition device for recording data on a driver of the motor vehicle during operation thereof with the driver assistance function;
an interface for transmitting the data from the first data acquisition device and the data from the second data acquisition device to a database, the data from the first data acquisition device and the data from the second data acquisition device being functionally networkable with one another via the database; and
an assessment device for evaluating the networked data.

This advantageously enables a driver behavior to be considered in the assessment and evaluation of the driver assistance function. This approach takes advantage of the fact that the motor vehicle has an external data connection, making it possible for data to be recorded and transmitted to a central server. A suitable, functional and networking processing of the data makes it possible to assess and evaluate a driver assistance function by preparing comprehensive data material on the surroundings and the driver. This makes it possible to advantageously use a representative mass of drivers who participate in the evaluation of the driver assistance function and, accordingly, make comprehensive data available.

Advantageous embodiments of the method and of the device are described herein.

An advantageous embodiment of the method provides for recording third data on surroundings of another motor vehicle that is in the same traffic situation as the motor vehicle. This makes it possible to receive feedback on another road user, thereby enhancing a robustness of the driver assistance function.

An advantageous embodiment of the method provides for executing classification algorithms in the assessment step, whereby a practical usability of the driver assistance function is determined. This makes it possible for the networked data to be meaningfully evaluated and analyzed.

Another advantageous embodiment of the method provides for implementing at least one of the following in the assessment step: classifying a driver experience, assessing safety goals, assessing safety factors, assessing operating parameters of the motor vehicle and of the objective lens, assessing the driver assistance function. This makes possible a very flexible analysis of the networked data. An individual, very flexible assessment or evaluation of the driver assistance function is thereby supported.

Another advantageous embodiment of the method provides that a wireless Internet connection of the motor vehicle be used for transmitting the data to the database. This makes it possible for an existing high-speed data connection of motor vehicles to the Internet to be used in order to also record and transmit high data volumes.

Another advantageous embodiment of the method provides that a focus be on data of the motor vehicle and/or on data of the further motor vehicle in the assessment step. This makes it possible to enhance a robustness of the evaluation of the driver assistance function by considering a focus or perspective of a road user in question and/or of another participant in the traffic situation.

Another advantageous embodiment of the method provides that the driver assistance function in the assessment step either be enabled or classified for improvement measures. A flexible treatment of the driver assistance function is supported in this manner as a function of the assessment result.

The present invention is described in greater detail in the following with reference to other features and advantages on the basis of a figure. All of the described or presented features constitute the subject matter of the present invention, either alone or in any combination, regardless of the manner in which they are combined herein, as well as independently of the formulation or presentation thereof in the description herein or in the figure. The primary purpose of the figure is to clarify the general principles of the present invention.

### BRIEF DESCRIPTION OF THE DRAWING

FIG. 1 is a schematic block diagram of a specific embodiment of the device according to the present invention.

### DETAILED DESCRIPTION OF EXAMPLE EMBODIMENTS

The disadvantages mentioned above reveal that it is not possible to use the V-model to comprehensively evaluate driver assistance functions because the technical options thereof do not suffice. Driven road kilometers on the order of approximately 100 million km are required when automated driving is exclusively used to validate on-road testing. This is based on the statistically based assumption that a fatal accident occurs for every 100 million kilometers driven.

The present invention provides a method for collecting data on the driver as well during his/her travel in the motor vehicle in addition to the vehicle data from sensor information. The thus obtained driver data undergo an analysis and are used to make possible a non-functional development assessment for enabling the driver assistance function.

In this way, an additional aspect may be advantageously introduced into the validation of the driver assistance function, in particular how a driver experiences a specific driving situation, and how he/she interacts with the automated driver assistance system.

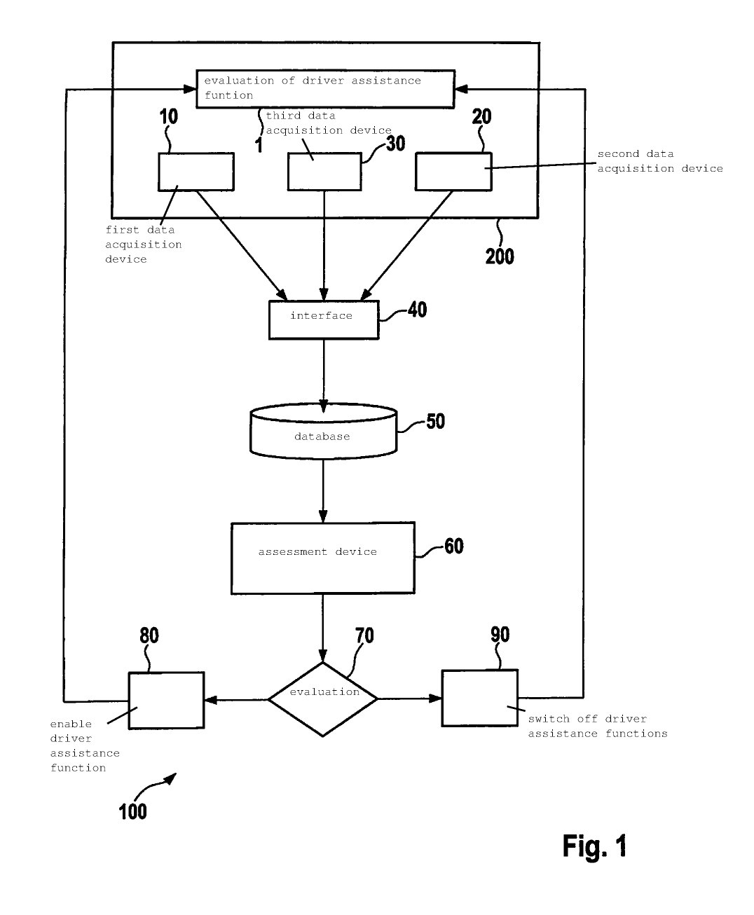

FIG. 1 shows a basic functional circuit diagram of a device 100 for evaluating a driver assistance function of a motor vehicle.

A first data acquisition device 10 records field data inside and outside of motor vehicle 200 that were captured by vehicle sensors (not shown).

A second data acquisition device 20 monitors the driver with the aid of what is generally known as “driver sensors” (not shown), for example, a video camera, sensors for recording a seating position, a steering wheel holding position, etc. Second data acquisition device 20 may be used to store driver events and/or human biosystematic events, for example.

An optional third data acquisition device 30 may be used to realize a connection to a social network, for example, in the form of a car-to-car communication or a car-to-infrastructure communication, whereby data from other road users participating in the same traffic situation are recorded and included in the evaluation of driver assistance function 1. This makes it advantageously possible to comprehensively assess the driver assistance function from different perspectives, for example, from the perspective of the driver of motor vehicle 200 and from the perspective of drivers of other motor vehicles in the same traffic situation.

The data from first data acquisition device 10, second data acquisition device 20, and third data acquisition device 30 are transmitted by an interface 40 to a database 50 located externally from motor vehicle 200. This is preferably carried out by a high-speed data connection that is increasingly available in motor vehicles.

Within database 50, the recorded data are functionally networked with one another. An assessment device 60 is used to evaluate driver assistance function 1. The criteria thereby used include, for example, a classification of a driver experience, a classification of a safety goal, a classification of safety factors, an assessment of operating parameters of motor vehicle 200 during operation (for example, pedal haptics, engine noise generation, etc.). Driver assistance function 1 may also be assessed in accordance with objective technical criteria.

An evaluation is made in an evaluation device 70 as a function of the assessment performed by assessment device 60; driver assistance function 1 being enabled in a step 80 in the case that such classifications have been fulfilled. Evaluation device 70 preferably includes an algorithm, respectively a unit for analyzing and classifying the obtained and stored data for the purpose of processing and assessing the field data with regard to the specified criteria.

Suitable specified criteria for technical evaluation may include, for example: a driver experience classification (for example, an emotional assessment of driver assistance function 1, such as a negative experience, inattention, positive experience, etc.), safety goals, safety factors, assessment metrics (for example, engine noise generation and/or braking, pedal feel, haptics, etc.), objective technical assessment of driver assistance function 1. Evaluation device 70 makes a decision about a further course of action for the technical development process of driver assistance function 1, for example, a decision about a further development of driver assistance function 1 when the vast majority of drivers are showing signs of a negative experience.

In a different case where the evaluation reveals that driver assistance function 1 must be further improved, driver assistance function 1 receives feedback in a step 90 for further adaptation thereof. In step 90, functions of driver assistance function 1 may also be switched off in the field.

To implement and apply the example method in accordance with the present invention, what is generally referred to as a driver monitoring technology is preferably used. Driver monitoring makes it possible to monitor driver states and record them using data technology.

Thus, the present invention makes it possible to include the driver's subjective experience of the situation/function in the validation of driver assistance function 1. Thus, in addition to purely functional events, non-functional events are also recorded and used for analyzing and assessing the driver behavior.

Mentioned here exemplarily is an automatically initiated braking of motor vehicle 200 until standstill: A driver assistance function 1 recognizes an obstacle, initiates braking, and brings vehicle 200 to a standstill at an adequate distance from the obstacle. The result is that driver assistance function 1 was correctly performed and all safety goals were met with sufficient factors.

The example method in accordance with the present invention is able to capture an important criterion, namely the question of whether the driver has experienced this situation of braking of motor vehicle 200. In this manner, data are recorded and obtained that make inferences possible about the driver and his/her experience situation associated therewith, and about his/her behavior and interaction in a specific situation.

This also makes it discernible, for example, whether and to what degree the driver is perceived to be in danger in the situation and has shown physiological stress reactions associated therewith (increased blood pressure and/or heart rate, pupil dilation, sweating, etc.). It is also possible to thereby discern whether the driver of motor vehicle 200 has noticeably reacted at all to the system behavior of driver assistance function 1.

Combining the data obtained on the driver and on the motor vehicle makes important and complex enable validations of functional and non-functional assessments quantifiable in the first place. This makes it possible to predict an acceptance in the case of a widespread implementation of driver assistance function 1.

In summary, the present invention provides a method and a device for evaluating a driver assistance function for an automated driving of a motor vehicle that advantageously allows non-functional assessment criteria for the driver assistance function to be used. A large number of evaluation participants makes it possible for a combinatorial effect of the data of the participants to significantly shorten a time to market of the driver assistance function.

One skilled in the art will suitably alter the features of the present invention and/or combine them with one another without departing from the spirit and scope thereof.

1-11. (canceled)

12. A method for evaluating a driver assistance function of a motor vehicle, comprising:
operating the motor vehicle using the driver assistance function;
recording first data on surroundings of the motor vehicle;
recording second data on a driver of the motor vehicle;
transmitting the first data and second data to a database;
functionally networking the first data and second data within the database; and
assessing the driver assistance function as a function of the networked data.

13. The method as recited in claim 12, wherein third data are recorded on surroundings of another motor vehicle that is in a same traffic situation as the motor vehicle.

14. The method as recited in claim 12, wherein evaluation algorithms are executed in the assessment step, a practical usability of the driver assistance function being determined.

15. The method as recited in claim 12, wherein at least one of the following is implemented in the assessing step: classifying a driver experience, assessing safety goals, assessing safety factors, assessing operating parameters of the motor vehicle, objectively assessing the driver assistance function.

16. The method as recited in claim 12, wherein a wireless Internet connection of the motor vehicle is used for transmitting the data to the database.

17. The method as recited in claim 13, wherein a focus is on at least one of data of the motor vehicle and data of the further motor vehicle, in the assessing step.

18. The method as recited in claim 12, wherein in the assessing step, the driver assistance function either being enabled or classified for improvement measures.

19. A device for evaluating a driver assistance function of a motor vehicle, comprising:
a first data acquisition device for recording data from surroundings of the motor vehicle during an operation of the motor vehicle with the driver assistance function;
a second data acquisition device for recording data on a driver of the motor vehicle during operation of the motor vehicle with the driver assistance function;
an interface for transmitting the data from the first data acquisition device and the data from the second data acquisition device to a database, the data from the first data acquisition device and the data from the second data acquisition device being functionally networkable with one another via the database; and
an assessment device for evaluating the networked data.

20. The device as recited in claim 19, further comprising:
a third data acquisition device, data from surroundings of another motor vehicle being ascertainable by the third data acquisition device.

21. The device as recited in claim 20, wherein the third data acquisition device includes a data transmission in accordance with at least one of the following communication principles:
car-to-car, car-to-infrastructure.

22. A non-transitory machine-readable storage medium on which is stored a computer program including program code for evaluating a driver assistance function of a motor vehicle, the computer program, when executed on an electronic control device, causing the electronic control device to perform:
operating the motor vehicle using the driver assistance function;
recording first data on surroundings of the motor vehicle;
recording second data on a driver of the motor vehicle;
transmitting the first data and second data to a database;
functionally networking the first data and second data within the database; and assessing the driver assistance function as a function of the networked data.
